(19) United States
(12) Patent Application Publication
(10) Pub. No.: US 2008/0280600 A1
(43) Pub. Date: Nov. 13, 2008

(54) Geographic Mobile Address Book

(75) Inventor: Xiaogang Zhou, Plano, TX (US)

Correspondence Address: CONLEY ROSE, P.C., 5601 GRANITE PARKWAY, SUITE 750, PLANO, TX, 75024, US

(73) Assignee: Samsung Electronics Co., Ltd., Kyungki-do (KR)

(21) Appl. No.: 11/745,914

(22) Filed: May 8, 2007

(51) Int. Cl. H04M 3/42

(52) U.S. Cl. 455/415

(57) ABSTRACT

A mobile device is provided that comprises a processor and an address book configured to provide a display to display a current geographic location of a contact associated with an entry in the address book.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

An easily transportable device with wireless telecommunications capabilities, such as a mobile telephone, a personal digital assistant, a handheld computer, or a similar device, will be referred to herein as a mobile device. Mobile devices typically include an address book feature for storing and organizing contact information. An address book might allow contacts to be organized into groups with common characteristics, such as family, friends, or coworkers.

### SUMMARY

In one embodiment, a mobile device is provided. The mobile device includes a processor and an address book configured to provide a display to display a current geographic location of a contact associated with an entry in the address book.

In another embodiment, a method for providing location information is provided. The method includes displaying on a mobile device an entry in an address book and displaying on the mobile device an indicator of a geographic location of a contact associated with the entry.

In another embodiment, a system is provided. The system includes an application server configured to promote display on a mobile device a plurality of entries in an address book. The entries include indicia related to geographic locations of contacts associated with the entries.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1a illustrates a portion of a geographic mobile address book according to an embodiment of the disclosure.

FIG. 1b illustrates a map that might be displayed in conjunction with a geographic mobile address book according to an embodiment of the disclosure.

FIG. 2a illustrates a portion of a geographic mobile address book according to an alternative embodiment of the disclosure.

FIG. 2b illustrates a portion of a geographic mobile address book according to another alternative embodiment of the disclosure.

FIG. 3a illustrates a portion of a geographic mobile address book according to another alternative embodiment of the disclosure.

FIG. 3b illustrates a map that might be displayed in conjunction with a geographic mobile address book according to an alternative embodiment of the disclosure.

FIG. 4 illustrates a system for displaying contact location information according to an embodiment of the disclosure.

FIG. 5 illustrates an embodiment of a method for displaying contact location information according to an embodiment of the disclosure.

FIG. 6 is a diagram of a wireless communications system including a mobile device operable for some of the various embodiments of the disclosure.

FIG. 7 is a block diagram of a mobile device operable for some of the various embodiments of the disclosure.

FIG. 8 is a diagram of a software environment that may be implemented on a mobile device operable for some of the various embodiments of the disclosure.

### DETAILED DESCRIPTION

It should be understood at the outset that although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Traditionally, an address book for a mobile device has been an application stored within the memory of the mobile device itself. However, the capabilities of a device-based address book might be limited by the limited processing power and memory space typically available on a mobile device. To provide enhanced capabilities, some telecommunications service providers have begun implementing address book applications on networks to which mobile devices have access. The computing power available via the network allows the creation of address books with additional features and storage space. The use of a network-based address book also facilitates the transfer of contact information when subscribers switch mobile devices and/or service providers.

In an embodiment, a network-based address book with a real-time dynamic view of the geographic location of a contact is provided. That is, in addition to the data fields that are traditionally displayed in an address book for a contact, such as name, telephone number, and email address, an additional field is provided that displays the contact's current location or a link to the contact's current location. The location might be represented by a graphical display such as a map, by a street address, by a city name, or by some other graphics-based or text-based information. The display of location information might show the location of a single contact, the locations of all members of a predefined group of contacts, or the locations of all contacts in a specified geographic area. A network-based address book that provides a real-time dynamic view of the geographic location of a contact in the address book will be referred to herein as a geographic mobile address book.

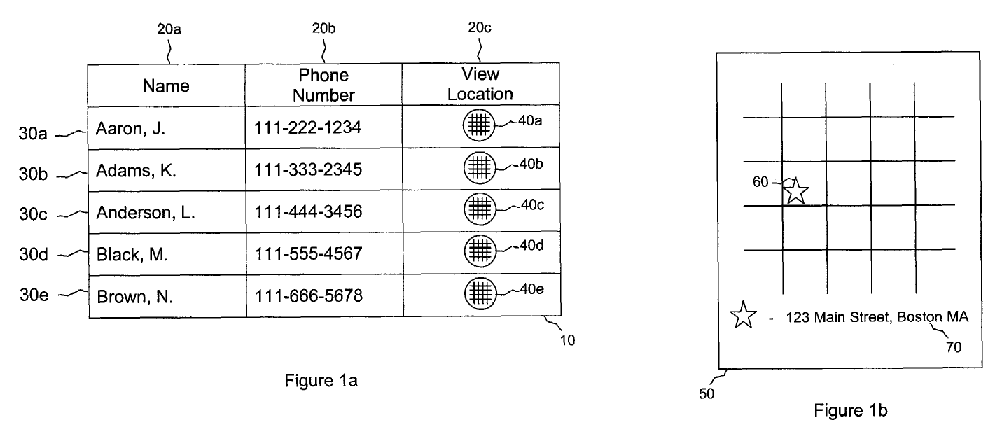

FIG. 1a illustrates an embodiment of a display that might appear on a mobile device that has access to a geographic mobile address book. The display shows a table 10 with a plurality of columns 20 of data categories and a plurality of rows 30, each displaying data associated with a contact. As used herein, the term “entry” will refer to the set of data on a single row 30 of a geographic mobile address book and the term “contact” will refer to a person or a group of persons associated with an entry. In the embodiment of FIG. 1a, a Name column 20a, a Phone Number column 20b, and a View Location column 20c are present, but in other embodiments other columns could be present.

The View Location column 20c contains an icon 40, a button, or some other type of data entry mechanism associated with each of the entries. The term “icon” will be used herein to refer to any portion of a graphical user interface on a mobile device that, when selected, causes the mobile device to perform an action. In the embodiment of FIG. 1a, when one of the icons 40 is selected, a map showing the current geographic location of the contact associated with that icon 40 is displayed. That is, when one of the icons 40 is selected, the mobile device no longer displays the table 10 of address book entries of FIG. 1a, but instead displays a map 50 such as that of FIG. 1b.

The map 50 might include an indicator 60 to indicate the current location of the contact who is associated with the icon 40 that was selected. A text-based description 70 of the location might also appear on or near the map 50. The scale of the map 50 might automatically be adjusted to provide an appropriate view of the location based on the information available for the contact. For example, if the location of the contact is known at the level of accuracy of a street address, the map 50 might be a street map. If the city in which the contact is located is known but the contact's current street address in that city is not known, the map 50 might have a larger scale. Zoom controls, scroll controls, and other well known map navigation tools might appear with the map 50. The indicator 60 might move about in the map 50 to reflect the movements of the contact.

In another embodiment, rather than an icon being associated with each of the entries, a single location-related icon might be displayed in a geographic mobile address book. A mobile device user might highlight one of the entries in the address book and then select the single icon to request a map of the location of the contact associated with the highlighted entry. A map similar to the map 50 of FIG. 1b might then be displayed.

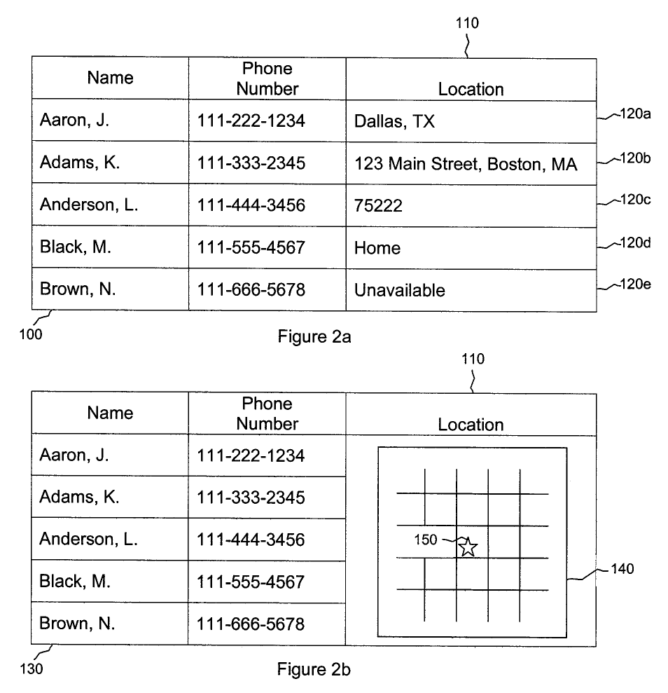

FIG. 2a illustrates an embodiment of another table 100 that might appear in a geographic mobile address book. In this case, the table 100 includes a Location column 110 rather than the View Location column 20c depicted in FIG. 1a. The Location column 110 might provide real-time, text-based location information for each of the contacts associated with each of the entries in the geographic mobile address book. That is, geographic location information for each contact can be viewed concurrently with other information about each contact. The text-based information might indicate each contact's current city as in row 120a, current street address and city as in row 120b, current zip code as in row 120c, or some other indicator of geographic location. The text-based information might also be a code word that has previously been established to indicate a location. For example, if a contact's current street address is known and it is also known that that address is the contact's home address, the Location column 110 might display the word ‘home’, as in row 120d. If a contact's current location is unknown, appropriate text might be displayed in the Location column 110, as in row 120e. In this embodiment, the user of the mobile device need not perform any action, such as selecting an icon, to retrieve location information. Instead, the location information is automatically pushed to the user's mobile device.

FIG. 2b illustrates an alternative embodiment of the table 100 of FIG. 2a. In this table 130, rather than the Location column 110 containing a plurality of rows 120, each displaying the current location of a different contact, the Location column 110 contains a map 140. When a mobile device user highlights one of the entries in the table 130, the map 140 in the Location column 110 displays the current location of the contact associated with that entry. The map 140 might be similar to the map 50 of FIG. 1b in having an indicator 150 of the contact's location, an appropriate scale, appropriate navigation controls, and other features. In a variation of this embodiment, the map 140 does not appear within the table 130 but is displayed elsewhere on the screen of the mobile device at the same time that the table 130 is displayed. Each time the user highlights a different entry, a different map 140 might appear on the screen.

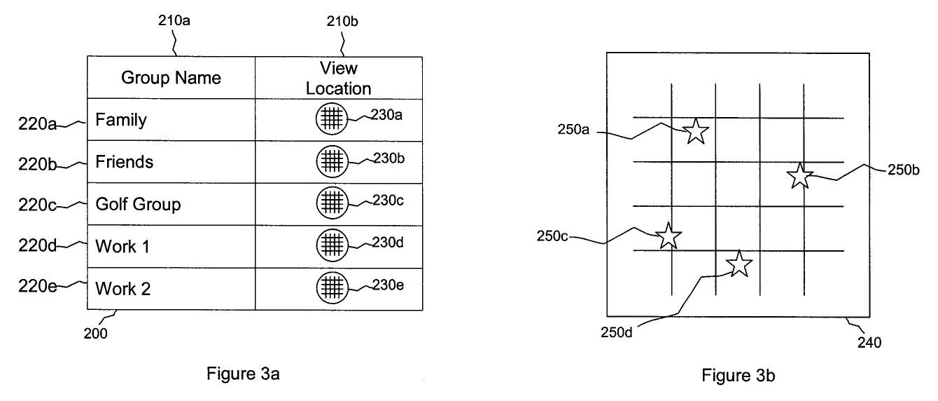

It is well known that the entries in an address book can be arranged into groups with common characteristics, such as family or friends. In an embodiment, a geographic mobile address book can display entries arranged by groups. This is illustrated in FIG. 3a, where a table 200 of entries includes a Group Name column 210a and a View Location column 210b that are similar to the Name column 20a and the View Location column 20c of FIG. 1a. Instead of each row in the table 200 being associated with a different individual contact, as in FIG. 1a, each row 220 in the table 200 of FIG. 3a is associated with a different group of contacts. One of skill in the art will recognize that the table 10 of individual contacts and the table 200 of groups of contacts would not necessarily be separate tables but might be a single table with entries for individual contacts and entries for contact groups interspersed with one another. An icon 230 is associated with each group and selecting one of the icons 230 causes a map to be displayed showing the locations of one or more members of the associated group.

For example, the group Family might contain four members. Selecting the icon 230a associated with the Family group might cause the table 200 to be removed from the screen of the mobile device and cause the map 240 of FIG. 3b to be displayed. It can be seen that four indicators 250 appear on the map 240, each indicating the current location of a member of the Family group. The scale of the map 240 can be appropriate for the locations of the group members. For example, if all the members of a group are in the same city, a city map can be displayed, if all the members of a group are in different cities but in the same state, a state map can be displayed, and so on.

In another embodiment, a user of a mobile device with a geographic mobile address book can specify a geographic region and request the mobile device to display a map showing the locations of all of the user's contacts who are currently in that region. A map similar to the map 240 of FIG. 3b might then appear showing the specified region and the locations of any contacts who happen to be in that region. The specification of the region might be accomplished by entering text-based information, such as a city name or state name, into the mobile device, by selecting a region from a predefined list of regions, by selecting a portion of a map displayed on the mobile device, by specifying a radius from the user's current location, by specifying a radius from some other location, or by other techniques.

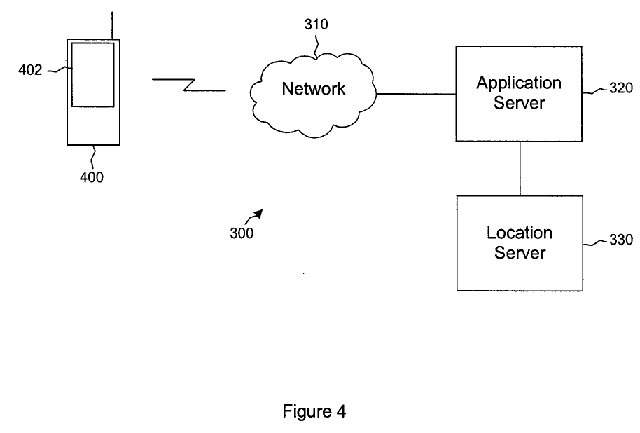

FIG. 4 illustrates an embodiment of a system 300 that might provide a mobile device 400 with the capabilities of a geographic mobile address book. The mobile device 400 can communicate wirelessly with a telecommunications network 310. The network 310 might be a Code Division Multiple Access (CDMA) network, a Global System for Mobile communication (GSM) network, or some other well known type of wireless telecommunications network. The network 310 might also be an IP (Internet Protocol) Multimedia Subsystem (IMS) network that enables the transmission of data in text, voice, video, and other media formats. The network 310 has access to an application server 320 and the application server 320 has access to a location server 330.

When a user of the mobile device 400 requests the location of a contact in the mobile device's geographic mobile address book, the request is handled by the application server 320. The application server 320 might include an application that provides the functionalities of the geographic mobile address book. The application server 320 queries the location server 330 for the location of the selected contact. The location server 330 might obtain location information from a Global Positioning System (GPS) in a mobile device being carried by the contact. The location server 330 returns the location to the application server 320 and the application server 320, via the network 310, causes the location information to appear in an appropriate form on a display screen 402 on the mobile device 400.

In the case where the user of the mobile device 400 requests the locations of a group of contacts, the application server 320 might determine who the members of the group are and then query the location server 330 for the locations of all of the members of the group. Upon receiving the location information from the location server 330, the application server 320 might create a map showing the locations of the group members and send the map to the mobile device 400.

In the case where the user requests the locations of all contacts in a given geographical region, the application server 320 might query the location server 330 for the locations of all contacts in the user's geographic mobile address book. Upon receiving that information, the application server 320 might determine which of the contacts are currently in the specified region. The application server 320 might then prepare a map of the region that indicates the locations of the contacts in the region and might send the map to the mobile device 400.

In an alternative embodiment, some or all of the functionality provided by the application server 320 resides on the mobile device 400. The mobile device 400 might receive location information from the location server 330 via the network 310 and the mobile device 400 might then cause the location information to appear in an appropriate form on its display screen 402.

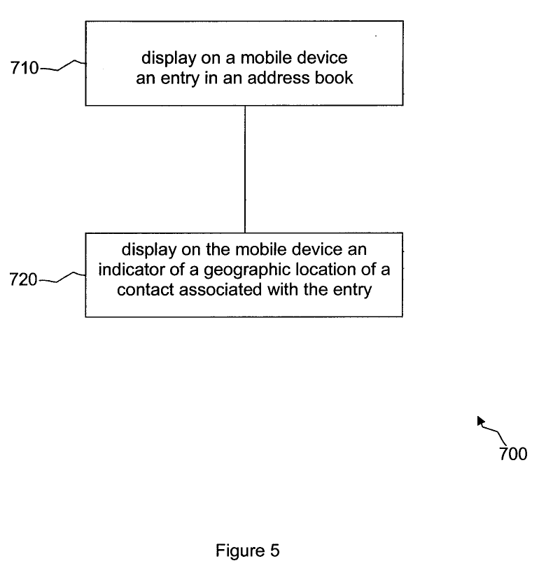

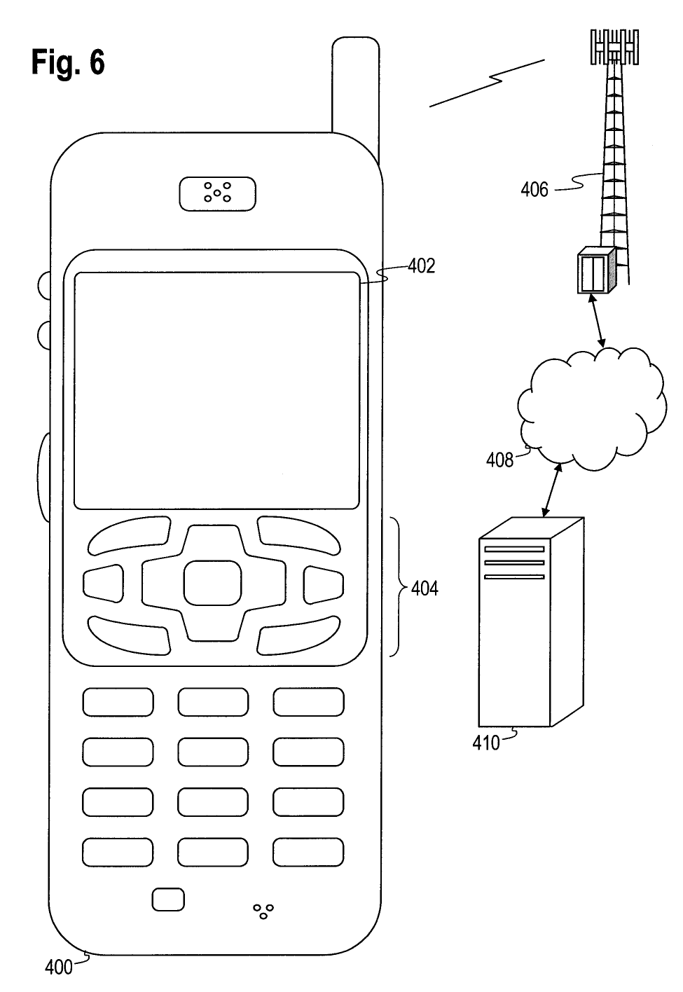

FIG. 5 illustrates an embodiment of a method 700 for displaying location information for a contact in a geographic mobile address book. At block 710, an entry in an address book is displayed on a mobile device. At block 720, an indicator of a geographic location of a contact associated with the entry is displayed on the mobile device.

FIG. 6 shows a wireless communications system including the mobile device 400 that may be operable for implementing aspects of the present disclosure, but the present disclosure should not be limited to these implementations. Though illustrated as a mobile phone, the mobile device 400 may take various forms including a wireless handset, a pager, a personal digital assistant (PDA), a portable computer, a tablet computer, or a laptop computer. Many suitable mobile devices combine some or all of these functions. In some embodiments of the present disclosure, the mobile device 400 is not a general purpose computing device like a portable, laptop or tablet computer, but rather is a special-purpose communications device such as a mobile phone, wireless handset, pager, or PDA.

The mobile device 400 includes the display 402 and a touch-sensitive surface or keys 404 for input by a user. The mobile device 400 may present options for the user to select, controls for the user to actuate, and/or cursors or other indicators for the user to direct. The mobile device 400 may further accept data entry from the user, including numbers to dial or various parameter values for configuring the operation of the mobile device 400. The mobile device 400 may further execute one or more software or firmware applications in response to user commands. These applications may configure the mobile device 400 to perform various customized functions in response to user interaction.

Among the various applications executable by the mobile device 400 are a web browser, which enables the display 402 to show a web page. The web page is obtained via wireless communications with a cell tower 406, a wireless network access node, or any other wireless communication network or system. The cell tower 406 (or wireless network access node) is coupled to a wired network 408, such as the Internet. The cell tower 406 and the wired network 408 may be substantially equivalent to the network 310 of FIG. 4. Via the wireless link and the wired network 408, the mobile device 400 has access to information on various servers, such as a server 410. The server 410 may provide content that may be shown on the display 402. The server 410 may be substantially equivalent to the application server 320 and/or the location server 330 of FIG. 4.

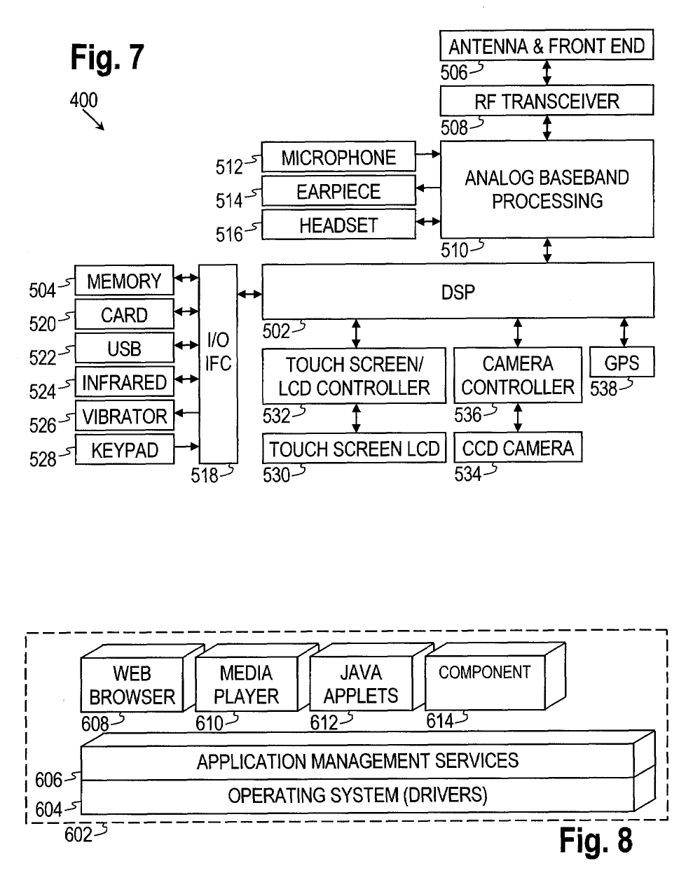

FIG. 7 shows a block diagram of the mobile device 400. The mobile device 400 includes a digital signal processor (DSP) 502 and a memory 504. As shown, the mobile device 400 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538.

The DSP 502 or some other form of controller or central processing unit operates to control the various components of the mobile device 400 in accordance with embedded software or firmware stored in memory 504. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the mobile device 400 to send and receive information from a cellular network or some other available wireless communications network. The RF transceiver 508 provides frequency shifting, converting received RF signals to baseband and converting baseband transmit signals to RF. The analog baseband processing unit 510 may provide channel equalization and signal demodulation to extract information from received signals, may modulate information to create transmit signals, and may provide analog filtering for audio signals. To that end, the analog baseband processing unit 510 may have ports for connecting to the built-in microphone 512 and the earpiece speaker 514 that enable the mobile device 400 to be used as a cell phone. The analog baseband processing unit 510 may further include a port for connecting to a headset or other hands-free microphone and speaker configuration.

The DSP 502 may send and receive digital communications with a wireless network via the analog baseband processing unit 510. In some embodiments, these digital communications may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the mobile device 400 to function as a peripheral device to exchange information with a personal computer or other computer system. The infrared port 524 and other optional ports such as a Bluetooth interface or an IEEE 802.11 compliant wireless interface may enable the mobile device 400 to communicate wirelessly with other nearby mobile devices and/or wireless base stations.

The input/output interface 518 may further connect the DSP 502 to the vibrator 526 that, when triggered, causes the mobile device 400 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the mobile device 400. Another input mechanism may be the touch screen LCD 530, which may also display text and/or graphics to the user. The touch screen LCD controller 532 couples the DSP 502 to the touch screen LCD 530.

The CCD camera 534 enables the mobile device 400 to take digital pictures. The DSP 502 communicates with the CCD camera 534 via the camera controller 536. The GPS sensor 538 is coupled to the DSP 502 to decode global positioning system signals, thereby enabling the mobile device 400 to determine its position. Various other peripherals may also be included to provide additional functions, e.g., radio and television reception.

FIG. 8 illustrates a software environment 602 that may be implemented by the DSP 502. The DSP 502 executes operating system drivers 604 that provide a platform from which the rest of the software operates. The operating system drivers 604 provide drivers for the handset hardware with standardized interfaces that are accessible to application software. The operating system drivers 604 include application management services (“AMS”) 606 that transfer control between applications running on the mobile device 400. Also shown in FIG. 8 are a web browser application 608, a media player application 610, and Java applets 612. The web browser application 608 configures the mobile device 400 to operate as a web browser, allowing a user to enter information into forms and select links to retrieve and view web pages. The media player application 610 configures the mobile device 400 to retrieve and play audio or audiovisual media. The Java applets 612 configure the mobile device 400 to provide games, utilities, and other functionality. A component 614 might provide functionality related to a geographic mobile address book.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A mobile device comprising:
a processor; and
an address book configured to provide a display to display a current geographic location of a contact associated with an entry in the address book.

2. The mobile device of claim 1 wherein the location is displayed as a text address.

3. The mobile device of claim 1 wherein the location is displayed as an indicator on a map.

4. The mobile device of claim 3 wherein the map is displayed upon a selection of an icon associated with the entry.

5. The mobile device of claim 1 wherein the current locations of a plurality of contacts are displayed.

6. The mobile device of claim 1 wherein the display provides an interface wherein the geographic location of the contact is viewable adjacent other information related to the contact.

7. The mobile device of claim 1 wherein the display provides an interface wherein the geographic location of the contact is viewable concurrently with other information about the contact.

8. A method for providing location information comprising:
displaying on a mobile device an entry in an address book; and
displaying on the mobile device an indicator of a geographic location of a contact associated with the entry.

9. The method of claim 8 further comprising displaying the geographic location of the contact upon selecting an icon associated with the entry.

10. The method of claim 8 further comprising selecting a group of entries from the address book and displaying the geographic locations of the contacts associated with the entries in the group.

11. The method of claim 8 further comprising specifying a geographic region and displaying the geographic locations of the contacts in the specified geographic region.

12. The method of claim 8 wherein the indicator of the geographic location and the entry are displayed concurrently.

13. A system comprising:
an application server configured to promote display on a mobile device a plurality of entries in an address book, the entries including indicia related to geographic locations of contacts associated with the entries.

14. The system of claim 13 wherein each of the plurality of entries comprises fields related to one of the contacts.

15. The system of claim 14 wherein the fields are one or more of a name field, an address field, a phone number field, and a location information field.

16. The system of claim 13 wherein the indicia are icons selectable to show the geographic locations of the contacts in a display different from the display of the entries.

17. The system of claim 13 wherein the geographic locations of a group of contacts are displayed.

18. The system of claim 13 wherein the locations of the contacts within a selected geographic region are displayed.

19. The system of claim 13 wherein a direction of movement of one of the contacts is displayed.

20. The system of claim 13 wherein the indicia are one of a map and an address.
